(19) United States
(12) Patent Application Publication
(10) Pub. No.: US 2021/0267286 A1
(43) Pub. Date: Sep. 2, 2021

(54) MASK

(71) Applicant: LG HOUSEHOLD & HEALTH CARE LTD., Seoul (KR)

(72) Inventors: Hwan HEO, Seoul (KR); Jung Hee WON, Seoul (KR); Min Ji KANG, Seoul (KR)

(73) Assignee: LG HOUSEHOLD & HEALTH CARE LTD., Seoul (KR)

(21) Appl. No.: 17/256,398

(22) PCT Filed: Jun. 28, 2019
(86) PCT No.: PCT/KR2019/007926

§ 371 Date: Dec. 28, 2020

(30) Foreign Application Priority Data
Jun. 29, 2018 (KR) 10-2018-0076024
Dec. 7, 2018 (KR) 10-2018-0157131
Jun. 26, 2019 (KR) 10-2019-0076654

(51) Int. Cl. A41D 13/11

(52) U.S. Cl. CPC A41D 13/1115; A41D 13/1161

(57) ABSTRACT

The present invention relates to a mask. The mask includes: a body part covering respiratory organs of a user; and a hanging part provided at each of both sides of the body part to allow the body part to be fixed to the respiratory organs of the user. The body part includes a chin cover part of a chin part, which forms a lower portion and surrounds chin of the user.

### TECHNICAL FIELD

The present invention relates to a mask, and more particularly, to a mask in which the structure of a nose part, a cheek part, a chin part, a mouth part, and a hanging part is improved, thereby enhancing the adhesion and three-dimensional effect on a face when a user wears the mask.

### BACKGROUND ART

As the amount of fine dust introduced to the country increases due to an increase in combustion of fossil fuel, which is caused by industrialization of China, together with fine dust generated within the country, exposure to fine dust have recently been increased. Fine dust includes a large quantity of toxic compounds and heavy metals, and it is known that, when a person sucks the fine dust, the fine dust causes diseases such as heart attack, asthma, bronchitis, pneumonia, and lung cancer.

According to a study, it is reported that the premature death of about 20,000 people for a year and lung associated diseases occur only in a capital area of the country due to fine dust. Masks are used to block the fine dust from being introduced into human bodies.

In addition, a case where people wear masks in daily life has increased so as to prevent infection or contagion from contagious bacteria which cause severe acute respiratory syndrome (SARS), Middle East respiratory syndrome (MERS) which has recently broken out within the country, flue, and the like.

In general, a mask is configured with a body part covering respiratory organs such as nose and mouth of a user and a hanging part provided as a means for allowing the mask to be fastened to the user. In some masks, a nose part covering nose and a chin part surrounding chin may be distinguished from each other so as to block the introduction of external air by enhancing comfortability in wearing or adhesion between the mask and face.

In general, a mask may be manufactured flat, to be folded and kept in a planar shape, and cover the periphery of respiratory organs while the shape of the mask is three-dimensionally deformed. The mask has used several structures capable of maintaining a three-dimensional shape so as to secure a sufficient respiratory space between nose or mouth and the mask.

A conventional flat type mask uses several configurations or structures to structurally maintain a three-dimensional shape, but does not solve the problem that the conventional mask makes a user feel inconvenience in keeping or lowers wearing sensation and adhesion sensation, even when the conventional mask secures a respiratory space.

Also, the conventional mask secures a respiratory space by allowing a body part covering respiratory organs such as nose and mouth to have a pleated shape. However, while the conventional mask can be manufactured through a simple manufacturing process, a large amount of air is leaked since adhesion to face of a user, i.e., cheek, nose, and chin is insufficient in wearing. In addition, while restriction when the user speaks or moves after wearing is relatively small due to wrinkles of the conventional mask in wearing, the conventional mask is not fixed to the center of the face due to low adhesion, when the user moves a facial area.

### DISCLOSURE

### Technical Problem

The present invention is conceived to solve the aforementioned problems. Accordingly, an object of the present invention is to provide a mask capable of prevent air leakage by enhancing adhesion at face (cheek, nose, and chin) of a user while having a three-dimensional shape at the periphery of respiratory organs when the user wears the mask.

### Technical Solution

In accordance with an aspect of the present invention, there is provided a mask including: a body part covering respiratory organs of a user; and an adhesion part formed at each of both side portions of the body part to have a three-dimensional shape with respect to the body part in wearing, the adhesion part being in contact with a facial area of the user.

Specifically, the adhesion part may be a cheek adhesion part adhered closely to a cheek of the user, and be aligned at each of both sides of the body part to extend from an upper side to a lower side.

Specifically, the cheek adhesion part may be stacked on the body part, and be configured in a flap structure which is opened toward the inside of the body part by fusing portions adhered closely to an upper surface, a side surface, and a lower surface of the body part.

Specifically, the cheek adhesion part may be formed of a non-air permeable material.

Specifically, the cheek adhesion part may be formed of a non-air permeable sheet, a laminate, or a non-air permeable urethane foam material.

Specifically, the body part may be formed in any one structure among a structure in which a side central portion is concave, a structure in which a side upper portion is concave, and a structure in which a side lower portion is concave so as to correspond to various face lines of the user.

Specifically, the body part may include a cheek part forming each of both side portions, the cheek part covering a cheek of the user; a nose part forming an upper portion, the nose part covering nose of the user; a chin part forming a lower portion, the chin part surrounding chin of the user; and a mouth part provided at the inside of the cheek part, the nose part, and the chin part to cover mouth of the user.

Specifically, the body part may be configured with a plurality of folding parts which are folded before wearing and are unfolded after wearing. Each of the plurality of folding parts may be configured with a wrinkle surface and a wrinkle line. The wrinkle shape of at least one upper folding part formed at an upper side with respect to a central folding part and the wrinkle shape of at least one lower folding part formed at a lower side with respect to the central folding part may be formed in directions opposite or equal to each other.

Specifically, a total size of the body part may be determined when the plurality of folding parts are unfolded, by adjusting an area ratio of the exposure portion and the non-exposure portion, sizes of the width and length of each of the folding parts, and a number of the folding parts.

Specifically, the body part may include: an outer fabric exposed to the outside; a filter provided at the inside of the outer fabric; and an inner fabric provided at the inside of the filter to face the respiratory organs. The outer fabric, the filter, and the inner fabric may be stacked.

Specifically, the body part may further include a rigid intermediate member stacked between the outer fabric and the filter. The rigid intermediate member may be plastic mesh.

Specifically, the cheek part may include the adhesion part. The adhesion part may have a shape corresponding to that of each of both the sides of the body part.

Specifically, the cheek part may include a first cheek fusion part which extends from a side upper corner to a side lower corner, and is configured with a fusion line provided in a curved line shape. In the fusion line, a dotted line or solid line which is more distant from a side as approaching the top-bottom center may have continuity.

Specifically, the cheek part may further include a second cheek fusion part which is formed to fuse a wrinkle line of the lower folding part, which is located downward of a portion most distant from a side in the curved line of the first cheek fusion part among the plurality of folding part, and is configured with a fusion line in which a dotted line or solid line has discontinuity.

Specifically, the cheek part may include a cheek pressure part which is formed at each of both the side portions of the body part, and is formed in the outer fabric while having a three-dimensional effect, to allow the facial part to be pressed by the hanging part in wearing.

Specifically, the cheek pressure part may be formed to allow a portion of the hanging part covered thereby in a state in which the hanging part is located at the inside of the body part.

Specifically, the cheek part may include a cheek sealing part which is formed at each of both the side portions of the body part, and is formed between the outer fabric and the inner fabric while having a three-dimensional effect, to allow the facial area to be sealed by the hanging part in wearing.

Specifically, the nose part may include a nose iron which forms an upper portion of the body part, has a shape of which the left and right are parallel to each other or a shape of which height become higher as approaching the left-right center, and is inserted into an upper side of the nose part or is inserted adjacent to the upper side.

Specifically, the nose iron may have a shape corresponding to a facial shape at the periphery of the ridge of the nose. The nose iron may use a coated wire as a material thereof. The coated wire may have a length of 50.5 mm to 200.0 mm, a width of 2.0 mm to 10.0 mm, and a thickness of 0.50 mm to 2.50 mm such that a modulus N (n+10) becomes 1.50 N or more and 5.00 N or less.

Specifically, the nose part may include nose fusion points which are respectively formed at both sides from the left-right center, and have a certain area.

Specifically, the nose fusion points may be formed at a wrinkle surface of a corresponding folding part in contact with the tip of the nose of the user among the plurality of folding parts.

Specifically, the nose part may include a nose sealing part which is formed at an upper side of the body part, and is formed between the outer fabric and the inner fabric while having a three-dimensional effect, to allow the facial area to be sealed by the hanging part in wearing.

Specifically, the nose part may include a nose cover part surrounding the nose of the user. The nose cover part may be aligned at the upper side of the nose part to extend from one side to the other side of the nose part.

Specifically, the nose cover part may be made of the same material as the body part. The nose cover part may be formed to be opened toward the inside of the nose part, by extending a material forming the plurality of folding parts constituting the body part to be greater by a certain length than an expected size of the material, laterally folding the extended material after the plurality of folding parts are formed, and then fusing the one side and the other side of the nose part.

Specifically, the nose cover part may be stacked on the nose part, and be formed to be opened toward the inside of the nose part by fusing portions adhered closely to the upper side, the one side, and the other side of the nose part.

Specifically, the nose cover part may be formed of a non-air permeable material.

Specifically, the nose cover part may be formed of a non-air permeable sheet, a laminate, or a non-air permeable urethane foam material.

Specifically, the chin part may include a chin cover part surrounding the chin of the user. The chin cover part may be aligned at a lower side of the chin part to extend from one side to the other side of the chin part.

Specifically, the chin cover part may be formed to be opened toward the inside of the chin part, by extending a material forming the plurality of folding parts constituting the body part to be greater by a certain length than an expected size of the material, laterally folding the extended material after the plurality of folding parts are formed, and then fusing the one side and the other side of the chin part.

Specifically, the chin cover part may be stacked on the chin part, and be formed to be opened toward the inside of the chin part by fusing portions adhered closely to the upper side, the one side, and the other side of the chin part. The chin cover part may be formed of a non-air permeable material.

Specifically, the chin cover part may be formed of a non-air permeable material.

Specifically, the chin cover part may be formed of a non-air permeable sheet, a laminate, or a non-air permeable urethane foam material.

Specifically, the mask may further include a hanging part provided at each of both the sides of the body part to allow the body part to be fixed to the respiratory organs of the user. The hanging part may have one end connected to an area of the body part, in which the chin cover part is not included, and the other end connected to an area of the body part, in which the chin cover part is included.

Specifically, the chin part may include a first chin fusion part which is formed to correspond to a chin line of the user at each of left and right lower corner portions, and is configured with at least one fusion line in which a dotted line or solid line has continuity.

Specifically, the thin part may include a second chin fusion part which is formed to fuse a wrinkle surface and a wrinkle line at a position corresponding to the chin line of the user in each of the left and right lower corner portions among the plurality of folding parts, and is configured with a fusion line in which a dotted line or solid line has discontinuity.

Specifically, the chin part may include a chin sealing part which is formed at a lower side of the body part, and is formed between the outer fabric and the inner fabric while having a three-dimensional effect, to allow the facial area to be sealed by the hanging part in wearing.

Specifically, the chin part may include a folding part surrounding the chin of the user. The folding part may be formed with a certain width along the lower side of the chin part.

Specifically, the folding part may be formed to extend the longitudinal length of the body part and to allow the extended portion to be folded inwardly.

Specifically, the width of the folding part may be in a range of 10% to 60% with respect to the longitudinal length of the body part.

Specifically, the hanging part may be connected to the folding part.

Specifically, the mouth part may include a mouth fusion part laterally extending by a certain length from the left-right center.

Specifically, the mouth fusion part may be formed at a wrinkle surface of a corresponding folding part located between the tip of the nose and the mouth of the user among the plurality of folding parts, and be configured with at least one fusion line in which a dotted line or solid line has continuity.

Specifically, the mouth part may include a rigid part laterally extending by a certain length from the left-right center.

Specifically, the rigid part may be formed at a corresponding folding part located between the tip of the nose and the mouth of the user among the plurality of folding parts.

Specifically, the rigid part may be stacked between the outer fabric and the filter of the body part on a wrinkle surface of the corresponding folding part.

Specifically, the mask may further include a hanging part provided at each of both the sides of the body part to allow the body part to be fixed to the respiratory organs of the user and the hanging part may be connected to an upper portion of the body part by a first connection part, and be connected to a lower portion of the body part by a second connection part.

Specifically, the second connection part may be formed to be biased toward the left-right center as compared with the first connection part.

Specifically, each of the first connection part and the second connection part may be formed to be biased toward the top-bottom center from the upper and lower corners of the body part.

Specifically, the length of the hanging part may be 100 mm to 250 mm.

Specifically, the mask may further include a first hanging part and a second hanging part, which are provided at upper and lower sides of the body part to allow the body part to be fixed to the respiratory organs of the user. The first hanging part may be fixed by connection parts respectively provided at left and right upper ends of the body part, and the second hanging part may be fixed by connection parts respectively provided at left and right lower ends of the body part.

### Advantageous Effects

In the mask in accordance with the present invention, the structure of the cheek part, the nose part, the chin part, the mouth part, and the hanging part is improved to improve the adhesion to the facial area and to enhance the three-dimensional effect, so that the convenience and reliability of the user can be improved.

Also, in the mask in accordance with the present invention, the wrinkle shape of the upper folding part and the wrinkle shape of the lower folding part are formed in directions opposite to each other with respect to the central folding part among the plurality of folding part constituting the body part, so that the upper and lower wrinkles can be individually unfolded according to the face size of the user. Accordingly, the three-dimensional sensation can be enhanced, and simultaneously, the wearing sensation of the user can be enhanced.

Also, in the mask in accordance with the present invention, both the sides of the body part or the structure of the lower side of the body part is formed in various structures to be suitable for various cheek shapes of users. Accordingly, the adhesion to cheeks or chins of the users can be improved in wearing, and air leakage in the vicinity of the cheeks or the chins can be prevented.

Also, in the mask in accordance with the present invention, the cheek adhesion part having the flap structure is formed in the cheek part, or the cheek fusion parts, the cheek pressure part, and the cheek sealing part are formed in the cheek part. Accordingly, the adhesion to the cheek of the user can be improved in wearing, and air leakage in the vicinity of the cheek can be prevented.

Also, in the mask in accordance with the present invention, the nose iron is applied while the shape of the upper side of the nose part corresponds to that of the ridge of the nose of the user. Accordingly, the adhesion to the nose of the user can be improved in wearing, and air leakage in the vicinity of the nose can be prevented.

Also, in the mask in accordance with the present invention, the nose cover part is formed in the nose part, to surround the nose in wearing. Thus, the adhesion to the nose can be improved, and simultaneously, the fixation to the nose can be improved. Accordingly, air leakage in the vicinity of the nose can be prevented.

Also, in the mask in accordance with the present invention, the chin cover part is formed in the chin part, to surround the chin in wearing. Thus, the adhesion to the chin can be improved, and simultaneously, the fixation to the chin can be improved. Accordingly, air leakage in the vicinity of the chin can be prevented. In addition, the wearing shape of the mask is constantly maintained due to improved adhesion and fixation even when the user wears the mask for a long period of time or when the user speaks in wearing, thereby enhancing the wearing sensation of the user.

Also, in the mask in accordance with the present invention, the nose sealing part is formed in the nose part, and the chin sealing part is formed in the chin part, so that the nose and the chin are respectively sealed by the nose sealing part and the chin sealing part when the user wears the mask. Accordingly, air leakage at an upper portion of the nose and a lower portion of the chin can be prevented.

Also, in the mask in accordance with the present invention, the nose fusion points are formed in the nose part, so that the three-dimensional effect of the respiratory portion in wearing can be improved.

Also, in the mask in accordance with the present invention, the first chin fusion part configured with the fusion line having continuity is formed in the chin part. Accordingly, the adhesion to the chin of the user in wearing can be improved, and air leakage in the vicinity of the chin can be prevented.

Also, in the mask in accordance with the present invention, the second chin fusion part configured with the fusion line having continuity, which fuses only the wrinkle line of the folding part, is formed in the chin part, so that a respiratory space can be provided at a portion generated when the folding part is unfolded. Accordingly, the three-dimensional effect of the respiratory portion can be improved.

Also, in the mask in accordance with the present invention, the mouth fusion part or the rigid part is formed in the mouth part, so that the three-dimensional effect of the respiratory portion in wearing can be improved.

Also, in the mask in accordance with the present invention, the hanging parts are provided at both the upper and lower sides of the body part, so that air leakage can be prevented, which occurs at both cheeks when a user having a face size smaller than an average size wears a mask which is larger than face of the user.

### BRIEF DESCRIPTION OF THE DRAWINGS

FIG. 1 is a front view of a mask in accordance with an embodiment of the present invention.

FIG. 2 is a view illustrating a configuration of a body part in accordance with the present invention.

FIG. 3 is a view illustrating a first embodiment of the body part in accordance with the present invention.

FIG. 4 is a view illustrating a second embodiment of the body part in accordance with the present invention.

FIG. 5 is a view illustrating a third embodiment of the body part in accordance with the present invention.

FIG. 6 is a view illustrating a fourth embodiment of the body part in accordance with the present invention.

FIG. 7 is a view illustrating a fifth embodiment of the body part in accordance with the present invention.

FIG. 8 is a view illustrating a sixth embodiment of the body part in accordance with the present invention.

FIG. 9 is a view illustrating a first embodiment of a cheek part in accordance with the present invention.

FIG. 10 is a view illustrating a second embodiment of the cheek part in accordance with the present invention.

FIG. 11 is a view illustrating a third embodiment of the cheek part in accordance with the present invention.

FIG. 12 is a view illustrating a first embodiment of a nose part in accordance with the present invention.

FIG. 13 is a view illustrating a second embodiment of the nose part in accordance with the present invention.

FIG. 14 is a view illustrating a third embodiment of a nose part or a first embodiment of a chin part in accordance with the present invention.

(a), (b), and (C) of FIG. 15 illustrate a state in which the mask shown in FIG. 14 is entirely or partially unfolded, (a) illustrates a state in which the mask is entirely unfolded, (b) illustrates a state in which the nose part is unfolded, and (c) illustrates a state in which the chin part is unfolded.

FIG. 16 is a view illustrating a fourth embodiment of the nose part or a second embodiment of the chin part in accordance with the present invention.

FIG. 17 is a view illustrating a third embodiment of the chin part in accordance with the present invention.

FIG. 18 is a view illustrating a fourth embodiment of the chin part in accordance with the present invention.

FIG. 19 is a view illustrating a fifth embodiment of the chin part in accordance with the present invention.

FIG. 20 is a view illustrating a first embodiment of a mouth part in accordance with the present invention.

FIG. 21 is a view illustrating a second embodiment of the mouth part in accordance with the present invention.

FIG. 22 is a view illustrating a first embodiment of a hanging part in accordance with the present invention.

FIG. 23 is a view illustrating a second embodiment of the hanging part in accordance with the present invention.

FIG. 24 is a view illustrating a third embodiment of the hanging part in accordance with the present invention.

### MODE FOR THE INVENTION

Other objects, specific advantages, and new features of the present invention will be more apparent from preferable embodiments and the following detailed description associated with the accompanying drawings. In the specification, when reference numerals are endowed to components in each drawing, it should be noted that like reference numerals denote like elements even though they are depicted in several drawings. Further, in the following description of the present invention, a detailed explanation of known related technologies may be omitted to avoid unnecessarily obscuring the subject matter of the present invention.

Hereinafter, exemplary embodiments of the present invention will be described in detail with reference to the accompanying drawings.

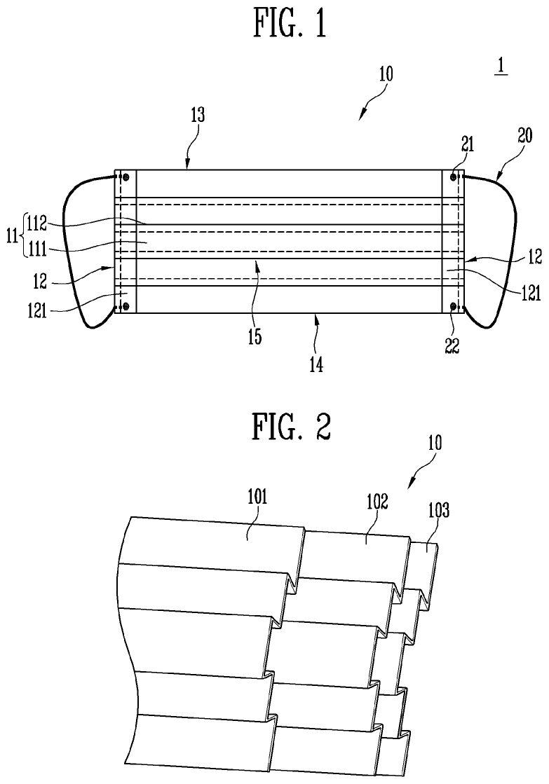

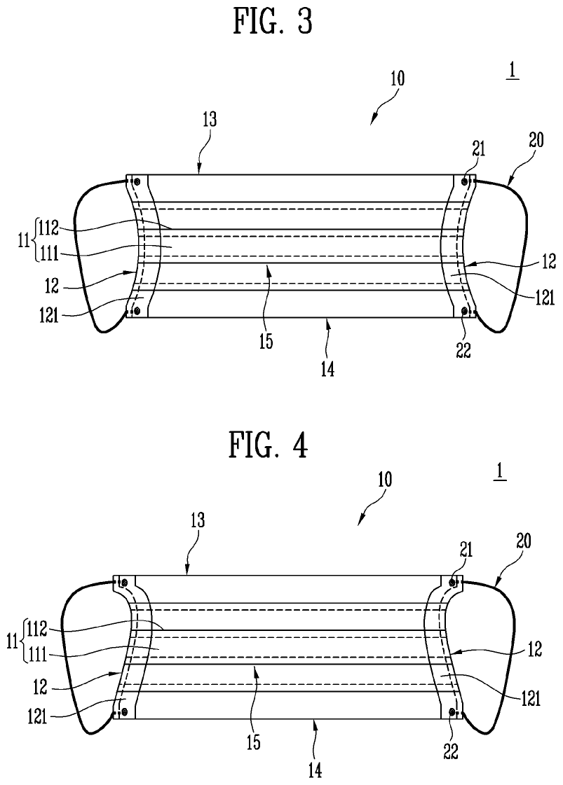

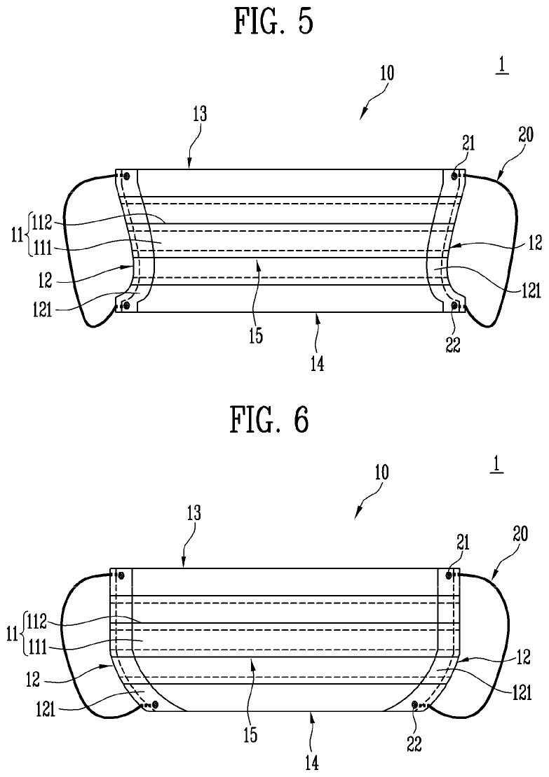

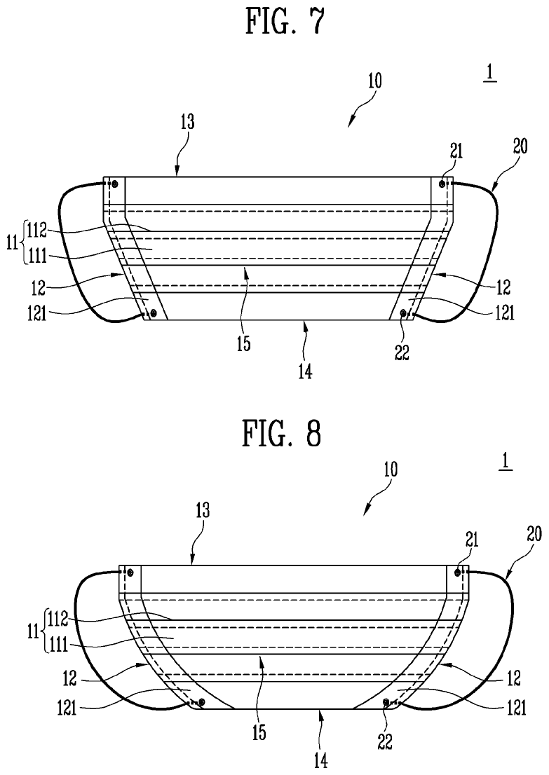

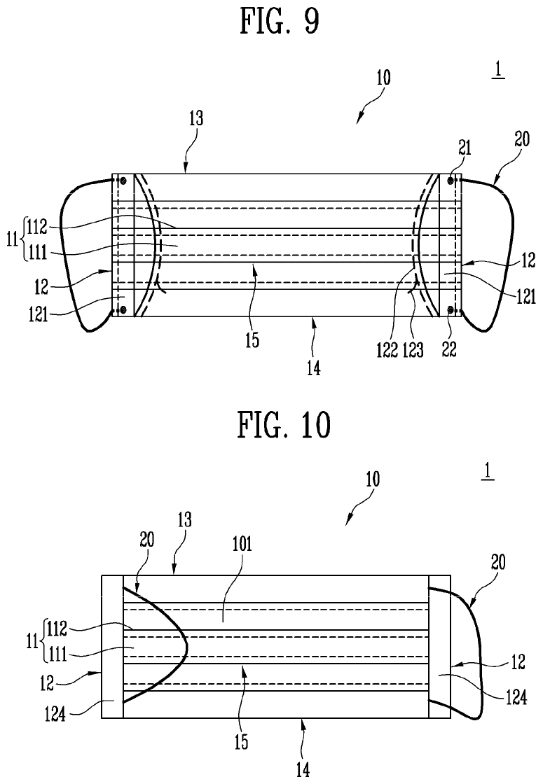

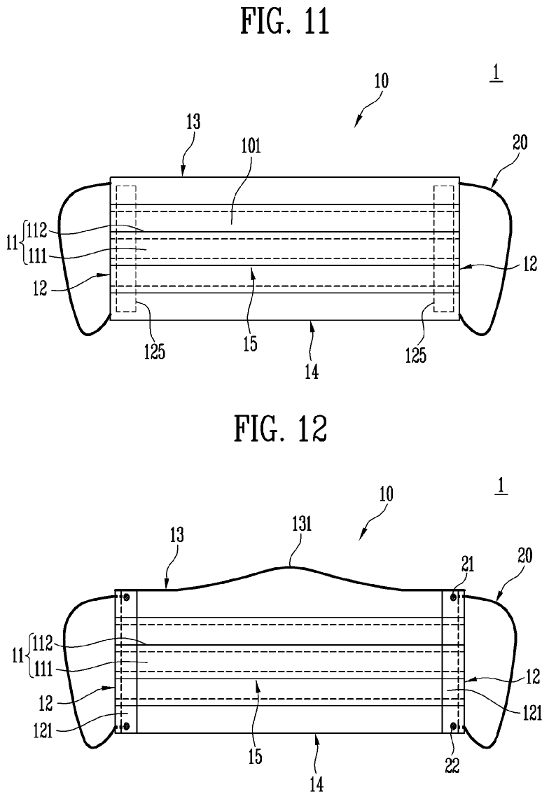

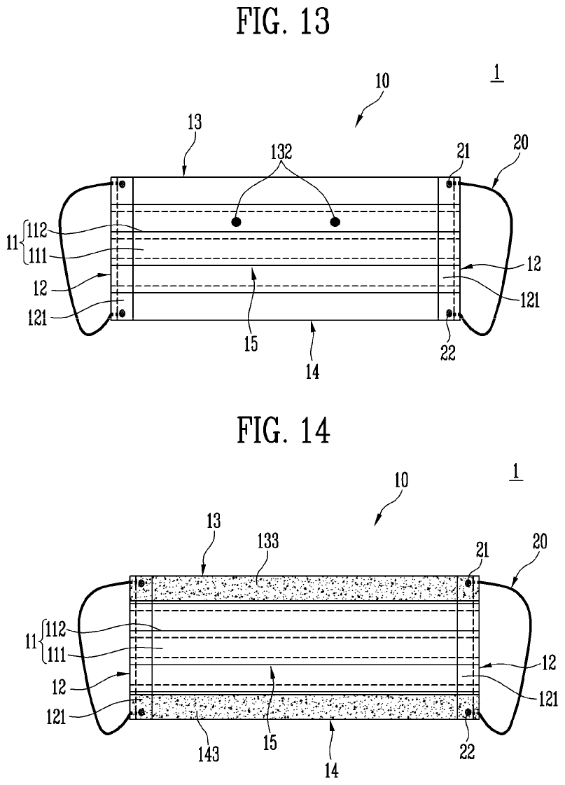

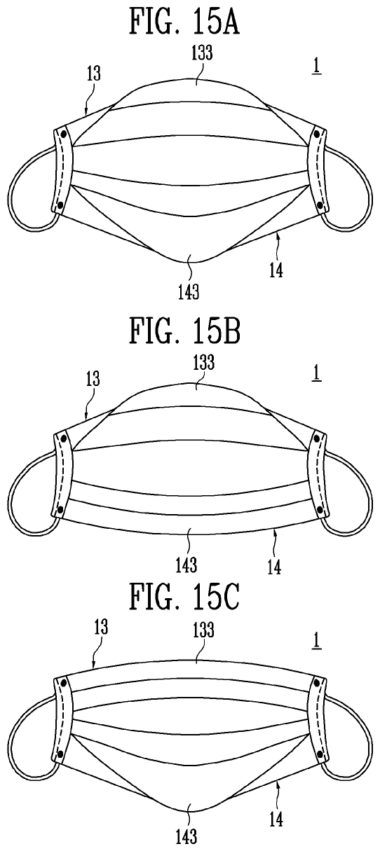

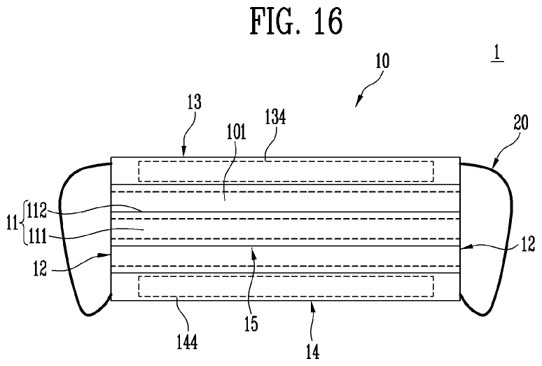

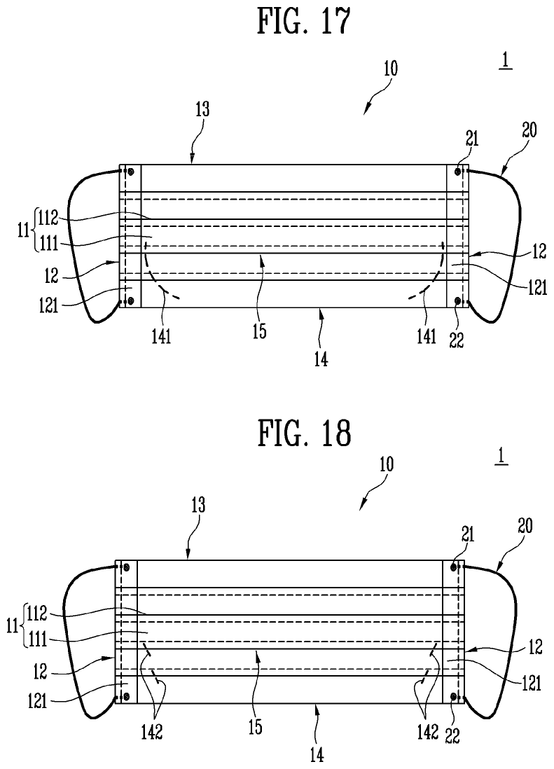

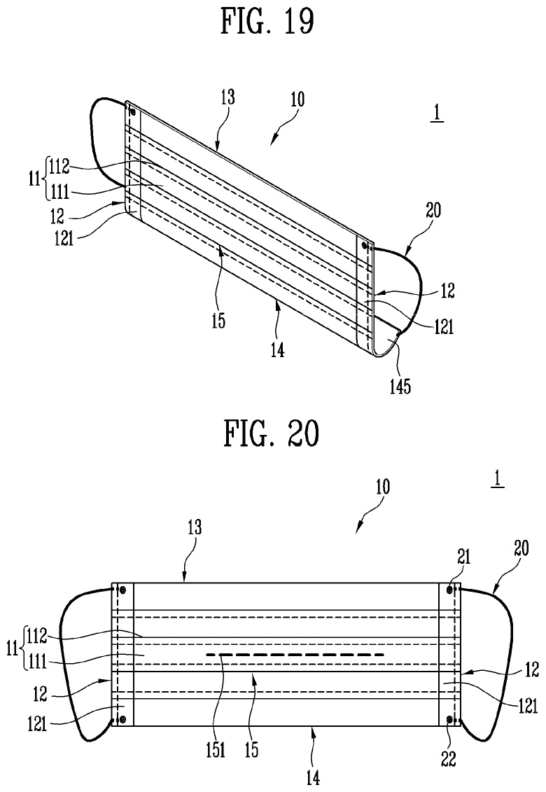

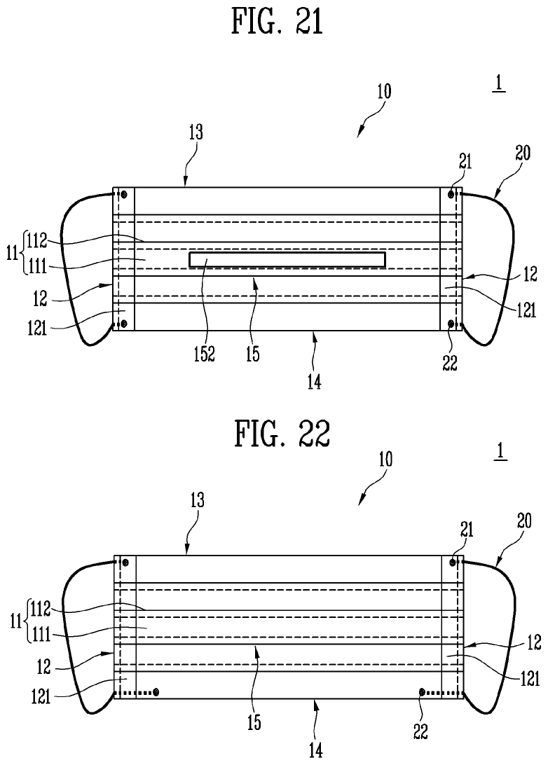

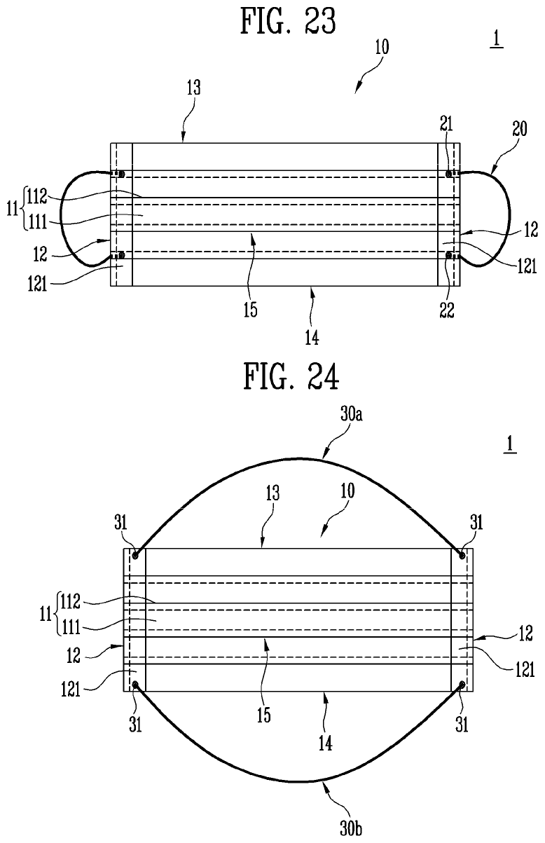

FIG. 1 is a front view of a mask in accordance with an embodiment of the present invention. FIG. 2 is a view illustrating a configuration of a body part in accordance with the present invention. FIG. 3 is a view illustrating a first embodiment of the body part in accordance with the present invention. FIG. 4 is a view illustrating a second embodiment of the body part in accordance with the present invention. FIG. 5 is a view illustrating a third embodiment of the body part in accordance with the present invention. FIG. 6 is a view illustrating a fourth embodiment of the body part in accordance with the present invention. FIG. 7 is a view illustrating a fifth embodiment of the body part in accordance with the present invention. FIG. 8 is a view illustrating a sixth embodiment of the body part in accordance with the present invention. FIG. 9 is a view illustrating a first embodiment of a cheek part in accordance with the present invention. FIG. 10 is a view illustrating a second embodiment of the cheek part in accordance with the present invention. FIG. 11 is a view illustrating a third embodiment of the cheek part in accordance with the present invention. FIG. 12 is a view illustrating a first embodiment of a nose part in accordance with the present invention. FIG. 13 is a view illustrating a second embodiment of the nose part in accordance with the present invention. FIG. 14 is a view illustrating a third embodiment of a nose part or a first embodiment of a chin part in accordance with the present invention. (a), (b), and (C) of FIG. 15 illustrate a state in which the mask shown in FIG. 14 is entirely or partially unfolded, (a) illustrates a state in which the mask is entirely unfolded, (b) illustrates a state in which the nose part is unfolded, and (c) illustrates a state in which the chin part is unfolded. FIG. 16 is a view illustrating a fourth embodiment of the nose part or a second embodiment of the chin part in accordance with the present invention. FIG. 17 is a view illustrating a third embodiment of the chin part in accordance with the present invention. FIG. 18 is a view illustrating a fourth embodiment of the chin part in accordance with the present invention. FIG. 19 is a view illustrating a fifth embodiment of the chin part in accordance with the present invention. FIG. 20 is a view illustrating a first embodiment of a mouth part in accordance with the present invention. FIG. 21 is a view illustrating a second embodiment of the mouth part in accordance with the present invention. FIG. 22 is a view illustrating a first embodiment of a hanging part in accordance with the present invention. FIG. 23 is a view illustrating a second embodiment of the hanging part in accordance with the present invention. FIG. 24 is a view illustrating a third embodiment of the hanging part in accordance with the present invention.

Referring to FIGS. 1 to 8, the mask 1 in accordance with the embodiment of the present invention includes a body part 10 and a hanging part 20.

The body part 10 covers respiratory organs of a user. As shown in FIG. 2, the body part 10 may be configured such that an outer fabric 101, a filter 102, and an inner fabric 103 are stacked. The outer fabric 101 is exposed to the outside, the filter 102 is provided at the inside of the outer fabric 101, and the inner fabric 103 is provided at the inside of the filter 102 to face the respiratory organs of the user. The inner fabric 103 is a part in direct contact with skin, and it is desirable that make-up smearing does not occur when the user wear the mask 1. To this end, felt having an embossed shape may be applied as a material of the inner fabric.

Also, although not shown in the drawings, the body part 10 may further include a rigid intermediate member stacked between the outer fabric 101 and the filter 102. The rigid intermediate member may be plastic mesh.

Also, the body part 10 may be configured to have no wrinkle or be configured with a plurality of folding parts 11 which are folded before wearing and are unfolded after wearing.

Each of the plurality of folding parts 11 may be configured with a wrinkle surface 111 and a wrinkle line 112. The plurality of folding parts 11 may be configured such that the wrinkle shape of at least one upper folding part formed at an upper side with respect to a central folding part and the wrinkle shape of at least one lower folding part formed at a lower side with respect to the central folding part are formed in directions opposite or equal to each other, i.e., symmetrical to each other with respect to the central folding part.

The wrinkle shapes of the plurality of folding parts 11 are formed in directions opposite to each other with respect to the central folding part. The wrinkle shapes are configured as described above, so that the upper folding part is unfolded upwardly and the lower folding part is unfolded downwardly. An upper jawbone and a lower jawbone for each user have different sizes. For example, the wrinkle of the upper folding part is widely unfolded when in the case of a user having a large upper jawbone, and the wrinkle of the lower folding part corresponding to a relatively small lower jawbone is narrowly unfolded. Accordingly, the folding part 11 of the present invention can systematically react according to the face of a user, and thus wearing sensation, comfortable sensation, and adhesion sensation of the user can be enhanced. Unlike the present invention, when the wrinkle shapes are formed in the same direction, wrinkles are collectively unfolded in one direction, and hence wearing sensation, comfortable sensation, and adhesion sensation are lowered as compared with the present invention.

That is, among the plurality of folding part 11 constituting the body part 10, and the wrinkle shape of the upper folding part and the wrinkle shape of the lower folding part are formed in directions opposite to each other with respect to the central folding part, so that upper and lower wrinkles can be individually unfolded according to a face size of a user. Accordingly, three-dimensional sensation can be enhanced, and simultaneously, wearing sensation of the user can be enhanced.

In the body part 10 configured with the plurality of folding parts 11, an exposure portion and a non-exposure portion are generated by the wrinkle surface 111 and the wrinkle line 112 when the plurality of folding parts 11 are folded. An area ratio of the exposure portion and the non-exposure portion, sizes of the width and length of each of the folding parts 11, and a number of the folding parts 11 are adjusted, so that a total size of the body part 10 can be determined when the plurality of folding parts 11 are unfolded.

The body part 10 may be formed in any one structure among a structure in which a side central portion is concave, a structure in which a side upper portion is concave, and a structure in which a side lower portion is concave so as to correspond to various face lines of the user, and such a structure can improve the adhesion of cheeks.

As shown in FIG. 3, the structure in which the side central portion is concave is a structure which is gently inclined toward the inside of the body part 10 as approaching the left-right center from a side upper end and a side lower end of the body part 10, and can improve the adhesion of a cheek central line.

As shown in FIG. 4, the structure in which the side upper portion is concave is a structure which is rapidly inclined toward the inside of the body part 10 in the vicinity of the side upper end of the body part 10 and then gently inclined toward the outside of the body part 10 as approaching the side lower end of the body part 10, and can improve the adhesion of a cheek upper line.

As shown in FIG. 5, the structure in which the side lower portion is concave is a structure which is rapidly inclined toward the inside of body part 10 in the vicinity of the side lower end of the body part 10 and then gently inclined toward the outside of the body part 10 as approaching the side upper end of the body part 10, and can improve the adhesion of a cheek lower line.

Also, the body part 10 may be formed in any one structure among a structure in which a lower side is narrowed, a structure in which a lower side corner as an example is cut linearly or curvedly (see FIG. 6), and a structure in which both sides are narrowed as approaching a lower side (see FIGS. 7 and 8) so as to correspond to various face lines of the user, and such a structure can improve the adhesion of chin.

The body part 10 may include a cheek adhesion part 121 which is formed at each of both side portions to have a three-dimensional shape with respect to the body part 10, and serves as an adhesion part in contact with a facial area of the user.

The cheek adhesion part 121 in contact with a cheek of the user may be formed at each of both the side portions of the body part 10.

The cheek adhesion part 121 may be aligned at each of both sides of the body part 10 to extend from an upper side to a lower side. The cheek adhesion part 121 may be stacked on the body part 10 and be configured in a flap structure which is opened toward the inside of the body part 10 by fusing portions adhered closely to an upper surface, a side surface, and a lower surface of the body part 10.

The cheek adhesion part 121 may be formed of a non-air permeable material. The cheek adhesion part 121 may be formed of a non-air permeable sheet, a laminate, or a non-air permeable urethane foam material.

The body part 10 may include a cheek part 12 which forms each of both side portions and cover the cheek of the user, a nose part 13 which forms an upper portion and cover nose of the user, a chin part 14 which form a lower portion and surrounds chin of the user, and a mouth part 15 which is provided at the inside of the cheek part 12, the nose part 13, and the chin part 14 to cover mouth of the user.

In this embodiment, that the body part 10 is divided into the cheek part 12, the nose part 13, the chin part 14, and the mouth part 15 is merely help understanding, and the cheek part 12, the nose part 13, the chin part 14, and the mouth part 15 may be integrally provided without being divided by any boundary line.

Also, the body part 10 may include the hanging part 20 provided at each of both sides of the body part 10 to fix the body part 10 to the respiratory organs of the user.

The cheek part 12 may include the above-described cheek adhesion part 121.

The cheek adhesion part 12 may be applied to not only the structure of the body part 10, which is shown in FIG. 1, but also various structures of the body part, which are shown in FIGS. 3 to 8. The cheek adhesion part 121 has a shape corresponding to various structures.

Also, as shown in FIG. 9, the cheek part 12 may include a first cheek fusion part 122 which extends from a side upper corner to a side lower corner, and is configured with a fusion line provided in a curved line shape. In the fusion line, a dotted line or solid line which is more distant from a side as approaching the top-bottom center has continuity.

Also, the cheek part 12 may further include a second cheek fusion part 123 which is formed to fuse a wrinkle line 112 of the lower folding part, which is located downward of a portion most distant from a side in the curved line of the first cheek fusion part 122 among the plurality of folding part 11, and is configured with a fusion line in which a dotted line or solid line has discontinuity.

As described above, the cheek part 12 forms the cheek adhesion part 121 having the flap structure or forms the first cheek fusion part 122 and the second cheek fusion part 123, so that the adhesion to the cheek of the user in wearing can be improved.

As shown in FIG. 10, the cheek part 12 may include a cheek pressure part 124 which is formed at each of both the side portions of the body part 10, and is formed in the outer fabric 101 while having a three-dimensional effect, to allow the facial part to be pressed by the hanging part 20 when the user wears the mask 1.

The cheek pressure part 124 may be aligned at each of both the sides of the body part 10, to extend from the upper side to the lower side with a certain width. The cheek pressure part 124 may be stacked on the outer fabric 101 of the body part 10. The cheek pressure part 124 may be formed of a non-air permeable material. The cheek pressure part 124 may be formed of a material such as a non-air permeable sheet, a laminate, or a non-air permeable urethane foam.

Also, the cheek pressure part 124 may be formed to allow a portion of the hanging part 20 covered thereby in a state in which the hanging part 20 is located at the inside of the body part 10. Thus, the cheek pressure part 124 is formed to allow the portion of the hanging part 20 to be covered thereby, so that the hanging part 20 directly presses the cheek pressure part 124 in wearing, thereby increasing pressure.

As described above, the cheek part 12 presses the cheek of the user by the cheek pressure part 124 having the three-dimensional effect in wearing, so that air leakage from the cheek can be prevented.

As shown in FIG. 11, the cheek part 12 may include a cheek sealing part 125 which is formed at each of both the side portions of the body part 10, and is formed between the outer fabric 101 and the inner fabric 103 while having a three-dimensional effect, to allow the facial area to be sealed by the hanging part 20 in wearing.

The cheek sealing part 125 may be aligned at each of both the side portions of the body part 10, to extend from the upper side to the lower side with a certain width, and be interposed between the outer fabric 101 and the inner fabric 103 of the body part 10. The cheek sealing part 125 may be formed of a material such as a urethane foam or a bulky felt.

As described above, the cheek part 12 includes the cheek sealing part which allows the cheek is sealed by the cheek sealing part 125 having the three-dimensional effect in wearing, so that air leakage from the cheek can be prevented.

The nose part 13 forms an upper portion of the body part 10, and may have a shape of which the left and right are parallel to each other or a shape of which height become higher as approaching the left-right center. As shown in FIG. 12, the nose part 12 may include a nose iron 131 which is inserted into an upper side of the nose part 13 or is inserted adjacent to the upper side.

The nose iron 131 may have a shape corresponding to a facial shape at the periphery of the ridge of the nose. The nose iron 131 may use a coated wire as a material thereof. The coated wire may have a length of 50.5 mm to 200.0 mm, a width of 2.0 mm to 10.0 mm, and a thickness of 0.50 mm to 2.50 mm such that a modulus N (n+10) becomes 1.50 N or more and 5.00 N or less. Accordingly, the adhesion to the nose of the user can be enhanced.

In an example, as shown in the following table obtained by comparing the nose iron 131 of the present invention and the existing first and second nose irons, the modulus N (n+10) appears high when the nose iron 131 of the present invention is used. When the nose iron 131 of the present invention is used, the leakage rate of the mask 1 is 85% or more, which represents an improved result. For reference, a condition of a health mask KF80 is that the leakage rate of the health mask KF80 is 75% or more.

TABLE 1

| | Nose iron | Existing | Existing |
|---|---|---|---|
| | of present | first | second |
| Brand | invention | nose iron | nose iron |
| Material of nose | Coated wire | Coated wire | Coated wire |
| iron | | | |
| Modulus (N) | 2.39 | 0.562 | 1.3 |
| (n + 10) | | | |

Also, as shown in FIG. 13, the nose part 13 may include nose fusion points 132 which are respectively formed at both sides from the left-right center, and have a certain area. The nose fusion points 132 may be formed at a wrinkle surface of a corresponding folding part in contact with the tip of the nose of the user among the plurality of folding parts 11.

These nose fusion points 132 can improve the three-dimensional effect of a respiratory portion when the user wears the mask 1.

Also, as shown in FIG. 14, the nose part 13 may include a nose cover part 133 surrounding the nose of the user.

The nose cover part 133 may be aligned at the upper side of the nose part 13 to extend from one side to the other side of the nose part 13.

The nose cover part 133 may be made of the same material as the body part 10. The nose cover part 133 may be formed to be opened toward the inside of the nose part 13, by extending a material forming the plurality of folding parts 11 constituting the body part 10 to be greater by a certain length than an expected size of the material, laterally folding the extended material after the plurality of folding parts 11 are formed, and then fusing the one side and the other side of the nose part 13.

Also, the nose cover part 133 may be stacked on the nose part 13, and be formed to be opened toward the inside of the nose part 13 by fusing portions adhered closely to the upper side, the one side, and the other side of the nose part 13. The nose cover part 133 may be formed of a non-air permeable material, e.g., a non-air permeable sheet, a laminate, or a non-air permeable urethane foam material.

Since the nose cover part 133 is formed to be opened toward the inside of the nose part 13, as shown in (b) of FIG. 15, the nose cover part 133 surrounds the nose while being unfolded upwardly in wearing. Accordingly, the adhesion to the nose can be improved, and simultaneously, the fixation to the nose can be improved.

It will be apparent that the nose iron 131, at least one of the nose fusion points 132, and the nose cover part 133 may be combined and applied.

Also, as shown in FIG. 16, the nose part 13 may include a nose sealing part 134 which is formed at an upper side of the body part 10, and is formed between the outer fabric 101 and the inner fabric 103 while having a three-dimensional effect, to allow the facial area to be sealed by the hanging part 20 in wearing.

The nose sealing part 134 may be aligned at the upper side of the body part 10 to extend from the one side to the other side of the nose part 13. The nose sealing part 134 may be interposed between the outer fabric 101 and the inner fabric 103 of the body part 10. The nose sealing part 134 may be formed of a material such as a urethane foam or a bulky felt.

As described above, the nose part 13 allows an upper portion of the nose to be sealed by the nose sealing part 134 having the three-dimensional effect in wearing, so that air leakage at the upper portion of the nose can be prevented.

As shown in FIG. 14, the chin part 14 may include a chin cover part 143 surrounding the chin of the user.

The chin cover part 143 may be aligned at a lower side of the chin part 14 to extend from one side to the other side of the chin part 14.

The chin cover part 143 may be made of the same material as the body part 10. The chin cover part 143 may be configured by forming the body part 10 to be vertically longer, folding a lower end of the body part 10 and then sticking, fusing or depositing the folded lower end. Also, the chin cover part 143 may be formed to be opened toward the inside of the chin part 14, by extending a material forming the plurality of folding parts 11 constituting the body part 10 to be greater by a certain length than an expected size of the material, laterally folding the extended material after the plurality of folding parts 11 are formed, and then fusing the one side and the other side of the chin part 14. It will be apparent that the chin cover part 143 may be made of a material different from that of the body part 10.

Also, the chin cover part 143 may be stacked on the chin part 14, and be formed to be opened toward the inside of the chin part 14 by fusing portions adhered closely to the upper side, the one side, and the other side of the chin part 14. The chin cover part 143 may be formed of a non-air permeable material, e.g., a non-air permeable sheet, a laminate, or a non-air permeable urethane foam material.

Since the chin cover part 143 is formed to be opened toward the inside of the chin part 14, as shown in (c) of FIG. 15, like the nose cover part 133, the chin cover part 143 surrounds the chin while being unfolded downwardly in wearing. Accordingly, the adhesion to the chin can be improved, and simultaneously, the fixation to the chin can be improved.

It will be apparent that the nose cover part 133 and the chin cover part 143 may be simultaneously applied. As shown in (a) of FIG. 15, when the user wears the mask 1, the nose cover part 133 covers the nose and the chin cover part 143 surrounds the chin. Thus, the adhesion to the nose and the chin can be improved, and simultaneously, the fixation to the nose and the chin can be further improved. Accordingly, air leakage in the vicinity of the nose and the chin can be prevented.

The width of the chin cover part 143 may be in a range of 10% to 60% with respect to the longitudinal length of the body part 10. Accordingly, the chin cover part 143 can improve the leakage rate of the chin part 14 when the user wears the mask 1. Preferably, the width of the chin cover part 143 may be in a range of 25% to 50% with respect to the longitudinal length of the body part 10. Accordingly, the chin fixation to the chin cover part 143 is improved, and thus the mask 1 is prevented from moving upwardly when the user wears the mask 1 for a long period of time or when the user speaks in wearing, thereby enhancing the wearing sensation of the user.

In the structure having the chin cover part 143, the hanging part 20 provided at each of both the sides of the body part 10 to fix the body part 10 to the respiratory organs of the user may have one end connected to an area of the body part, in which the chin cover part 143 is not included, and the other end connected to an area of the body part, in which the chin cover part 143 is included.

The chin cover part 143 may be made of the same material as the body part 10. However, the chin cover part 143 may be formed to have flexibility as compared with the body part 10. For example, the chin cover part 143 may be formed by stacking a felt having a basis weight of 15 gsm to 60 gsm. The chin cover part 143 is formed with the felt having excellent flexibility due to a low basis weight, to be equally adhered closely to the entire chin regardless of various face shapes of users, thereby improving the leakage rate of the chin part 14.

Also, as shown in FIG. 16, the chin part 14 may include a chin sealing part 144 which is formed at a lower side of the body part 10, and is formed between the outer fabric 101 and the inner fabric 103 while having a three-dimensional effect, to allow the facial area to be sealed by the hanging part 20 in wearing.

The chin sealing part 144 may be aligned at the lower side of the body part 10 to extend from the one side to the other side of the chin part 14. The chin sealing part 144 may be interposed between the outer fabric 101 and the inner fabric 103 of the body part 10. The chin sealing part 144 may be formed of a material such as a urethane foam or a bulky felt.

As described above, the chin part 14 allows a lower portion of the chin to be sealed by the chin sealing part 144 having the three-dimensional effect in wearing, so that air leakage at the lower portion of the chin can be prevented.

Also, as shown in FIG. 17, the chin part 14 may include a first chin fusion part 141 which is formed to correspond to a chin line of the user at each of left and right lower corner portions, and is configured with at least one fusion line in which a dotted line or solid line has continuity.

In the above, the first chin fusion part 141 fuses a wrinkle surface and a wrinkle line at a position corresponding to the chin line of the user in each of the left and right lower corner portions among the plurality of folding parts 11, so that the adhesion to the chin of the user in wearing can be improved.

Also, as shown in FIG. 18, the thin part 14 may include a second chin fusion part 142 which is formed to fuse a wrinkle surface and a wrinkle line at a position corresponding to the chin line of the user in each of the left and right lower corner portions among the plurality of folding parts 11, and is configured with a fusion line in which a dotted line or solid line has discontinuity.

In the above, the second chin fusion part 142 fuses only a wrinkle line of the lower folding part among the plurality of folding parts 11, so that a wrinkle surface of the lower folding part is also unfolded when the plurality of folding parts 11 are unfolded, thereby providing a respiratory space. Accordingly, the three-dimensional effect of a respiratory portion can be improved.

Also, as shown in FIG. 19, the chin part 14 may include a folding part 145 surrounding the chin of the user.

The folding part 145 may be formed with a certain width along the lower side of the chin part 14.

The folding part 145 may be formed to extend the longitudinal length of the body part 10 surrounding the facial area and to allow the extended portion to be folded inwardly. The folding part 145 may be formed in a folding structure similar or identical to that of the plurality of folding part 11 constituting the body part 10. The folding part 145 is formed by using the extended portion of the body part 10, so that a plate-type mask having the folding part 145 can be easily produced through only a cutting process (however, cutting by extending the longitudinal length of the body part by the length of the folding part 142 in addition to the length of the body part) for forming the existing body part 10, without any additional cutting process for forming the folding part 145.

Although a case where the folding part 145 is formed to be extended from the body part 10 has been described in the above, it will be apparent that the folding part 145 may be formed by being separately attached to the lower side of the chin part 14.

The width of the folding part 145 may be in a range of 10% to 60% with respect to the longitudinal length of the body part 10. Accordingly, the folding part 145 can improve the leakage rate of the chin part 14 when the user wears the mask 1.

The hanging part 20 may be connected to the folding part 145. In general, the hanging part 20 is connected to the body part 10 to allow the body part 10 to be adhered closely to the facial area. However, in this embodiment, the hanging part 20 is connected to the folding part 145, so that the folding part 145 can be adhered and fixed more closely to the chin part 14 while allowing the body part 10 to be adhered closely to the facial area when the user wears the mask 1. Accordingly, the leakage rage of the chin part 14 can be further improved.

The folding part 145 may be made of the same material as the body part 10. However, the folding part 145 may be formed to have flexibility as compared with the body part 10. For example, the folding part 145 may be formed by stacking a felt having a basis weight of 15 gsm to 60 gsm. The folding part 145 is formed with the felt having excellent flexibility due to a low basis weight, to be equally adhered closely to the entire chin regardless of various face shapes of users, thereby improving the leakage rate of the chin part 14.

As shown in FIG. 20, the mouth part 15 may include a mouth fusion part 151 laterally extending by a certain length from the left-right center.

The mouth fusion part 151 may be formed at a wrinkle surface of a corresponding folding part located between the tip of the nose and the mouth of the user among the plurality of folding parts 11, and be configured with at least one fusion line in which a dotted line or solid line has continuity.

Also, as shown in FIG. 21, the mouth part 15 may include a rigid part 152 laterally extending by a certain length from the left-right center.

The rigid part 152 may be formed at a corresponding folding part located between the tip of the nose and the mouth of the user among the plurality of folding parts 11.

Specifically, the rigid part 152 may be stacked between the outer fabric 101 and the filter 102 of the body part 10 on a wrinkle surface of the corresponding folding part.

It will be apparent that the mouth fusion part 151 and the rigid part 152 may be combined and applied. The mouth fusion part 151 and the rigid part 152 can improve the three-dimensional effect of a respiratory portion when the user wears the mask 1.

The folding part 20 may be provided at each of both the sides of the body part 10 to allow the body part 10 to be fixed to the respiratory organs of the user.

The folding part 20 may be provided in the shape of a band worn around head of the user, an earring hung around an ear of the user, or the like. In this embodiment, a case where the hanging part 20 is provided in the shape of an earring will be described for convenience.

The hanging part 20 may be configured with a string having elasticity, such as spandex, and be fixed through various processes such as a process of fusing or pressing both ends of the string. Portions at which both the ends of the string are fixed may be designated as a first connection part 21 and a second connection part 22. That is, the hanging part 20 may implement a closed loop with respect to the first connection part 21 and the second connection part 22.

The hanging part 20 may be connected to an upper portion of the body part 10 by the first connection part 21, and be connected to a lower portion of the body part 10 by the second connection part 22.

The first connection part 21 and the second connection part 22 are generally formed at upper and lower corners of the body part 10. However, in this embodiment, the adhesion of the mask 1 can be improved by using the first connection part 21 and the second connection part 22.

Specifically, as shown in FIG. 22, the second connection part 22 may be formed to be biased toward the left-right center as compared with the first connection part 21. The position of the second connection part 22 is changed, so that the adhesion of the chin part 14 can be improved.

Also, as shown in FIG. 23, each of the first connection part 21 and the second connection part 22 may be formed to be biased toward the top-bottom center from the upper and lower corners of the body part 10. The distance between the first connection part 21 and the second connection part 22 are narrowed, so that the adhesion of the cheek part 12 can be improved.

Although a case where the hanging part 20 is provided at each of both the side portions of the body part 10 has been described in the above, as shown in FIG. 24, the hanging parts 30a and 30b may be provided at each of both upper and lower portions of the body part 10 to allow the body part 10 to be fixed to the respiratory organs of the user.

Referring to FIG. 24, the hanging parts 30a and 30b may be provided at both upper and lower sides of the body part 10. For convenience of description, the hanging part provided at the upper side is designated as a first hanging part 30a, and the hanging part provided at the lower side is designated as a second hanging part 30b.

The first hanging part 30a may be fixed by connection parts 31 respectively provided at left and right upper ends of the body part 10, and be hung around a back portion of the head when the user wears the mask 1.

The first hanging part 30a may be formed in the shape of a band worn around the head of the user.

The second hanging part 30b may be fixed by connection parts 31 respectively provided at left and right lower ends of the body part 10, and be hung around a back portion of neck when the user wears the mask 1.

The second hanging part 30b may be formed in the shape of a band worn around the back portion of the neck of the user.

The first and second hanging parts 30a and 30b are not pulled at both side portions to allow the body part 10 to be fixed to the facial area of the user, but pulled at upper and lower sides to allow the body part 10 to be fixed to the facial area of the user. Hence, air leakage can be prevented, which occurs at both cheeks when a user having a face size smaller than an average size wears a mask which is larger than face of the user.

The present invention is not limited to the above-described embodiments, and may include, as still another embodiment, a combination of the embodiments or a combination of at least one of the embodiments and a prior art.

As described above, in this embodiment, the structure of the cheek part 12, the nose part 13, the chin part 14, the mouth part 15, and the hanging part 20 is improved to improve the adhesion to the facial area and to enhance the three-dimensional effect, so that the convenience and reliability of the user can be improved.

Also, in this embodiment, the wrinkle shape of the upper folding part and the wrinkle shape of the lower folding part are formed in directions opposite to each other with respect to the central folding part among the plurality of folding part 11 constituting the body part 10, so that the upper and lower wrinkles can be individually unfolded according to the face size of the user. Accordingly, the three-dimensional sensation can be enhanced, and simultaneously, the wearing sensation of the user can be enhanced.

Also, in this embodiment, both the sides of the body part 10 or the structure of the lower side of the body part 10 is formed in various structures to be suitable for various cheek shapes of users. Accordingly, the adhesion to cheeks or chins of the users can be improved in wearing, and air leakage in the vicinity of the cheeks or the chins can be prevented.

Also, in this embodiment, the cheek adhesion part 121 having the flap structure is formed in the cheek part 12, or the cheek fusion parts 122 and 123, the cheek pressure part 124, and the cheek sealing part 125 are formed in the cheek part 12. Accordingly, the adhesion to the cheek of the user can be improved in wearing, and air leakage in the vicinity of the cheek can be prevented.

Also, in this embodiment, the nose iron 131 is applied while the shape of the upper side of the nose part 13 corresponds to that of the ridge of the nose of the user. Accordingly, the adhesion to the nose of the user can be improved in wearing, and air leakage in the vicinity of the nose can be prevented.

Also, in this embodiment, the nose cover part 133 is formed in the nose part 133, and the chin cover part 143 is formed in the chin part 14, so that the nose cover part 133 and the chin cover part 143 respectively surround the nose and the chin when the user wears the mask 1. Thus, the adhesion to the nose and the chin can be improved, and simultaneously, the fixation to the nose and the chin can be improved. Accordingly, air leakage in the vicinity of the nose and the chin can be prevented.

Also, in this embodiment, the nose sealing part 134 is formed in the nose part 13, and the chin sealing part 144 is formed in the chin part 14, so that the nose and the chin are respectively sealed by the nose sealing part 134 and the chin sealing part 144 when the user wears the mask 1. Accordingly, air leakage at an upper portion of the nose and a lower portion of the chin can be prevented.

Also, in this embodiment, the nose fusion points 132 are formed in the nose part 13, so that the three-dimensional effect of the respiratory portion in wearing can be improved.

Also, in this embodiment, the first chin fusion part 141 configured with the fusion line having continuity is formed in the chin part 14. Accordingly, the adhesion to the chin of the user in wearing can be improved, and air leakage in the vicinity of the chin can be prevented.

Also, in this embodiment, the second chin fusion part 142 configured with the fusion line having continuity, which fuses only the wrinkle line 112 of the folding part 11, is formed in the chin part 14, so that a respiratory space can be provided at a portion generated when the folding part 11 is unfolded. Accordingly, the three-dimensional effect of the respiratory portion can be improved.

Also, in this embodiment, the mouth fusion part 151 or the rigid part 152 is formed in the mouth part 15, so that the three-dimensional effect of the respiratory portion in wearing can be improved.

Also, in this embodiment, the hanging parts 30a and 30b are provided at both the upper and lower sides of the body part 10, so that air leakage can be prevented, which occurs at both cheeks when a user having a face size smaller than an average size wears a mask which is larger than face of the user.

Although the present invention has been described in connection with the embodiments, the embodiments of the present invention are only for illustrative purposes and should not be construed as limiting the scope of the present invention. It will be understood by those skilled in the art that various changes and modifications can be made thereto within the technical spirit and scope defined by the appended claims. Therefore, it should be understood that the technical contents related to the modification and application that can be easily derived from the embodiments of the present invention are included in the present invention.

< Explanation of Reference Numerals for
Main Portions in Drawings >

| | | | |
|---|---|---|---|
| 1: | Mask | 10: | Body part |
| 101: | Outer fabric | 102: | Filter |
| 103: | Inner fabric | 11: | Folding part |
| 111: | Wrinkle surface | 112: | Wrinkle line |
| 12: | Cheek part | 121: | Cheek adhesion part |
| 122: | First cheek fusion part | 123: | Second cheek fusion part |
| 124: | Cheek pressure part | 125: | Cheek sealing part |
| 13: | Nose part | 131: | Nose iron |
| 132: | Nose fusion point | 133: | Nose cover part |
| 134: | Nose sealing part | 14: | Chin part |
| 141: | First chin fusion part | 142: | Second chin fusion part |
| 143: | Chin cover part | 144: | Chin sealing part |
| 145: | Folding part | 15: | Mouth part |
| 151: | Mouth fusion part | 152: | Rigid part |
| 20: | Hanging part | 21: | First connection part |
| 22: | Second connection part | 30a: | First hanging part |
| 30b: | Second hanging part | 31: | Connection part |

1. A mask comprising:
a body part covering respiratory organs of a user; and
a hanging part provided at each of both sides of the body part to allow the body part to be fixed to the respiratory organs of the user,
wherein the body part includes a chin cover part of a chin part, which forms a lower portion and surrounds chin of the user.

2. The mask of claim 1, wherein the body part is configured with a plurality of folding parts which are folded before wearing and are unfolded after wearing,
wherein each of the plurality of folding parts is configured with a wrinkle surface and a wrinkle line, and
wherein the wrinkle shape of at least one upper folding part formed at an upper side with respect to a central folding part and the wrinkle shape of at least one lower folding part formed at a lower side with respect to the central folding part are formed in directions opposite or equal to each other.

3. The mask of claim 1, wherein the body part includes:
an outer fabric exposed to the outside;
a filter provided at the inside of the outer fabric; and
an inner fabric provided at the inside of the filter to face the respiratory organs, and
wherein the outer fabric, the filter, and the inner fabric are stacked.

4. The mask of claim 1, wherein the chin cover part is aligned at a lower side of the chin part to extend from one side to the other side of the chin part.

5. The mask of claim 2, wherein the chin cover part is formed to be opened toward the inside of the chin part, by extending a material forming the plurality of folding parts constituting the body part to be greater by a certain size than an expected size of the material, laterally folding the extended material after the plurality of folding parts are formed, and then fusing the one side and the other side of the nose part.

6. The mask of claim 1, wherein the chin cover part is stacked on the chin part, and is formed to be opened toward the inside of the chin part by fusing portions adhered closely to the upper side, the one side, and the other side of the chin part.

7. The mask of claim 1, wherein the chin cover part the chin cover part is formed of a non-air permeable material.

8. The mask of claim 1, wherein the chin cover part is formed of a non-air permeable sheet, a laminate, or a non-air permeable urethane foam material.

9. The mask of claim 1, wherein the hanging part has one end connected to an area of the body part, in which the chin cover part is not included, and the other end connected to an area of the body part, in which the chin cover part is included.

10. The mask of claim 1, wherein the chin cover part the chin cover part is in a range of 10% to 60% with respect to a longitudinal length of the body part.

11. The mask of claim 1, wherein the chin cover part is in a range of 25% to 50% with respect to a longitudinal length of the body part.

12. The mask of claim 1, wherein the chin cover part is a felt having a basis weight of 15 gsm to 60 gsm.
